(19) United States
(12) Patent Application Publication
(10) Pub. No.: US 2006/0140678 A1
(43) Pub. Date: Jun. 29, 2006

(54) Developing unit and wet image forming apparatus having the same

(75) Inventor: Yu-Man Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/211,569

(22) Filed: Aug. 26, 2005

(30) Foreign Application Priority Data
Dec. 24, 2004 (KR) 2004-111798

(51) Int. Cl. G03G 15/10

(52) U.S. Cl. 399/237

(57) ABSTRACT

The developing unit has a developer receptacle containing liquid developer, a deposit roller rotatively disposed substantially below a surface of the liquid developer of the developer receptacle, a developing roller rotatively disposed over the deposit roller so that a part thereof submerges in the liquid developer and a metering roller rotatively disposed on a side of the developing roller over the surface of the liquid developer. The level of the liquid developer is maintained so that an angle between a first straight line joining a rotational center of the developing roller and a first intersection point where a circumferential surface of the developing roller intersects with the surface of the liquid developer below the metering roller and a second straight line joining the rotational center and a rotational center of the deposit roller is over about 20°.

### CROSS-REFERENCE TO RELATED APPLICATIONS

This application claims the benefit under 35 U.S.C. § 119(a) from Korean Patent Application No. 2004-111798, filed on Dec. 24, 2004, the entire disclosure of which is hereby incorporated by reference.

### BACKGROUND OF THE INVENTION

1. Field of the Invention

The present invention relates to an image forming apparatus. More particularly, the present invention relates to a developing unit using a liquid developer and a wet image forming apparatus having the same.

2. Description of the Related Art

It is well known that a wet image forming apparatus performs printing by using a liquid developer that is composed of solid toner particles and liquid developing carrier. In particular, a wet electro photographic image forming apparatus forms a predetermined electrostatic latent image on a surface of a photosensitive medium by using a laser beam scanned from a laser scanning unit. A developing unit develops the electrostatic latent image on the surface of the photosensitive medium into a visible image with the liquid developer. The developed image on the surface of the photosensitive medium is transferred to sheets of printing paper by a transferring unit, and then fused onto the printing paper by a fusing unit, thereby completing printing.

FIG. 1 shows a conventional developing unit 1 of a wet electro photographic image forming apparatus. Referring to FIG. 1, the developing unit 1 comprises a developing roller 10, a deposit roller 20, a metering roller 30, a developer receptacle 40, and a developer-supplying nozzle 42.

The developing roller 10 is disposed to rotate in contact with a photosensitive drum 50, and supplies toner particles for the photosensitive drum 50. The deposit roller 20 is disposed to rotate below the developing roller 10, and allows toner particles of a liquid developer L to form a toner layer on a surface of the developing roller 10. The metering roller 30 is disposed on a side of the developing roller 10, and regulates the toner layer in accordance with a predetermined height and removes liquid developing carrier that is over the predetermined thickness. The developer receptacle 40 is disposed below the deposit roller 20. The developer receptacle 40 receives liquid developer L that is supplied to the developing roller 10 by the developer-supplying nozzle 42. The developer receptacle 40 has a developer outlet 43 located on the bottom thereof, which discharges the liquid developer L received. Also, a cleaning roller 32 is disposed on the other side of the developing roller 10, and removes toner particles, which remain on the developing roller 10 after being transferred onto the photosensitive drum 50.

Next, a charging unit 51 for charging the surface of the photosensitive drum 50 to a predetermined voltage, a transferring unit 60 which transfers an image formed on the photosensitive drum 50 onto a sheet of printing paper, a cleaning blade 53 to remove the toner particles remaining on the photosensitive drum 50 after being transferred onto the printing paper by the transferring unit 60, and a charge eliminating unit 52 which eliminates the voltage remaining on the photosensitive drum 50 are also disposed around the photosensitive drum 50.

A process for the wet electro photographic image forming apparatus having the structure described above will be explained hereinafter.

When receiving a printing order, the laser-scanning unit (not shown) of the wet image forming apparatus scans a laser beam 55 corresponding to printing data, thereby forming an electrostatic latent image on the surface of the photosensitive drum 50. The photosensitive drum 50 is charged to a predetermined voltage by the charging unit 51. At this time, the voltage of the electrostatic latent image area on the surface of the photosensitive drum 50 is lower than the voltage of other areas of the drum 50. When the photosensitive drum 50 rotates, the electrostatic latent image area on the surface of the photosensitive drum 50 comes to face the developing roller 10 applied by a predetermined voltage. Therefore, toner particles, which form the toner layer on the surface of the developing roller 10, move to the photosensitive drum 50 via an electrical attraction between the photosensitive drum 50 and the developing roller 10, thereby developing the electrostatic latent image.

Hereinafter, a process in which the developing roller 10 supplies liquid developer L toner particles to the photosensitive drum 50 will be explained in detail.

The liquid developer L flows from the developer-supplying nozzle 42, and is supplied to a gap 11 between the developing roller 10 and the deposit roller 20. At this time, the developer-supplying nozzle 42 fluidly communicates with a liquid developer cartridge (not shown). The liquid developer L flows through the developer-supplying nozzle 42 via a pump (not shown) which is disposed between the developer-supplying nozzle 42 and the liquid developer cartridge. The liquid developer L comprises positively charged toner particles that are mixed with the liquid developing carrier in a predetermined concentration. A predetermined positive voltage is applied to the developing roller 10. The voltage being applied to deposit roller 20 is higher than to the developing roller 10. The voltage applied to the deposit roller 20 is typically 200˜500V higher than to the developing roller 10. Therefore, since toner particles of the liquid developer L located at the gap 11, between the developing roller 10 and the deposit roller 20, receive the electrical force in the direction of the developing roller 10 via a difference of electric potential between the developing roller 10 and the deposit roller 20. Consequently, the toner particles move to the developing roller 10 to form the toner layer on the surface of the developing roller 10. At this time, some liquid developing carrier moves to the developing roller 10 with the toner particles. When the developing roller 10 rotates, the toner layer formed on the developing roller 10 passes through between the developing roller 10 and the metering roller 30. The metering roller 30 removes excess liquid developer from the toner layer. Therefore, the toner layer comprises a suitable quantity of liquid developing and moves to the direction of the photosensitive drum 50. Then, the toner layer is used to develop the electrostatic latent image on the surface of the photosensitive drum 50 as described above.

The developed image on the surface of the photosensitive drum 50 is transferred to the printing paper (not shown) by the transferring unit 60, such as an intermediate transfer belt. The image transferred to the printing paper is fused on the printing paper while passing through the fusing unit (not shown). The printing paper on which the image is completely fused is discharged to the outside of the wet image forming apparatus, thereby completing printing.

In the prior art developing unit 1, which directly supplies the liquid developer L to the gap 11 between the developing roller 10 and the deposit roller 20 by the developer-supplying nozzle 42, the liquid developer L does not fill the gap 11 uniformly between the developing roller 10 and deposit roller 20. In other words, an entrance 11a of the gap 11 is filled with enough liquid developer L, but, an exit 11b of the gap 11 is not filled enough. Therefore, most of the toner layer on the developing roller 10 is mainly formed at the entrance 11a of the gap 11. The reason is that the electrical force in the gap 11 operates symmetrically with respect to a line joining a rotational center of the developing roller 10 and a rotational center of the deposit roller 20, so, a quantity of liquid developer L being transferred from the exit 11b of the gap 11 to the developing roller 10 is relatively small.

When quantities of liquid developer L being transferred from the entrance 11a and the exit 11b of the gap 11 between the developing roller 10 and the deposit roller 20 to developing roller 10 are different and printing speed is low, there is limited or no effect on printing quality. However, when the printing speed is high, it is relatively difficult for the liquid developer L to uniformly form a toner layer on the developing roller 10. When the toner layer formed on the developing roller 10 is not uniform, achieving good quality images having uniform image density is relatively difficult.

Accordingly, there is a need for an improved developing unit for a wet image forming apparatus which forms a uniform toner layer on a developing roller to achieve good quality images.

### SUMMARY OF THE INVENTION

An aspect of the present invention is to solve at least the above problems and/or disadvantages and to provide at least the advantages described below. Accordingly, an aspect of the present invention is to provide an improved developing unit of a wet image forming apparatus to allow toner particles to form a uniform toner layer on a developing roller.

Another aspect of the present invention is to provide a wet image forming apparatus which prints an image having uniform density because of a uniform toner layer on a developing roller.

Above aspects and advantages of the present invention are accomplished by providing a developing unit comprising a developer receptacle containing liquid developer, a deposit roller rotatively disposed substantially below a surface of the liquid developer of the developer receptacle, a developing roller rotatively disposed over the deposit roller so that a part thereof submerges in the liquid developer, and a metering roller rotatively disposed on a side of the developing roller over the surface of the liquid developer. The level of the liquid developer is maintained so that an angle A between a first straight line joining a rotational center of the developing roller and a first intersection point where a circumferential surface of the developing roller intersects with the surface of the liquid developer below the metering roller and a second straight line joining the rotational center of the developing roller and a rotational center of the deposit roller is over about 20°.

Also, the level of the liquid developer is maintained so that the angle A between the first straight line and the second straight line is below about 40°. And the developing roller is disposed so that an angle B between the second straight line and a third straight line joining the rotational center of the developing roller and a second intersection point where the circumferential surface thereof intersects with the surface of the liquid developer on the opposite side of the deposit roller from the metering roller is over about 20°.

The developing unit further comprises a level sensor sensing the level of the liquid developer. A developer-supplying unit fluidly communicates with the developer receptacle for supplying and withdrawing the liquid developer. A level controller controls the developer-supplying unit according to a signal of the level sensor so as to maintain a uniform liquid developer level.

The developing unit further comprises a deposit power supply applying a voltage to the deposit roller, and a developing power supply applying a voltage to the developing roller. The voltage applied to the deposit roller is about 200˜500V higher than to the developing roller. At this time, the developing power supply applies a voltage of about 500˜600V to the developing roller.

According to another aspect of the present invention, there is provided a wet image forming apparatus comprising a photosensitive medium on which an electrostatic latent image is formed. A developing unit develops the electrostatic latent image into a visible image and a transferring unit transfers the visible image formed on the photosensitive medium to printing paper. The developing unit comprises a developer receptacle containing liquid developer, a deposit roller rotatively disposed substantially below a surface of the liquid developer of the developer receptacle, a developing roller rotatively disposed in contact with the photosensitive medium over the deposit roller so that a part thereof submerges in the liquid developer, a metering roller rotatively disposed on a side of the developing roller over the surface of the liquid developer, a level sensor disposed on the developer receptacle which senses the level of the liquid developer, a developer-supplying unit supplying and withdrawing the liquid developer from the developer receptacle, and a level controller controlling the developer-supplying unit according to a signal of the level sensor so that the level of the liquid developer is maintained to allow an angle A between a first straight line joining a rotational center of the developing roller and a first intersection point where a circumferential surface of the developing roller intersects with the surface of the liquid developer below the metering roller and a second straight line joining the rotational center of the developing roller and a rotational center of the deposit roller is over about 20°.

At this time, the level of the liquid developer is maintained so that the angle A between the first straight line and the second straight line is below about 40°. Moreover, the developing roller is disposed so that an angle B between the second straight line and a third straight line joining the rotational center of the developing roller and a second intersection point where the circumferential surface thereof intersects with the surface of the liquid developer at the opposite side of developing roller from the metering roller is over about 20°.

The wet image forming apparatus further comprises a deposit power supply applying a voltage to the deposit roller and a developing power supply applying a voltage to the developing roller. The voltage applied to the deposit roller is about 200˜500V higher than the developing roller. At this time, it is preferable that the developing power supply applies a voltage of about 500˜600V to the developing roller.

According to the developing unit of the exemplary embodiments of the present invention, since the liquid developer is constantly supplied between the developing roller and the deposit roller, the toner particles are uniformly attached on the developing roller.

According to the wet image forming apparatus of the exemplary embodiments of the present invention, since the developing roller on which the toner particles are uniformly attached develops an image, it can provide a good quality printing matter having uniform image density.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWING FIGURES

The above and other objects, features, and advantages of certain embodiments of the present invention will be more apparent from the following description taken in conjunction with the accompanying drawings, in which:

FIG. 1 shows a conventional developing unit of a wet type image forming apparatus,

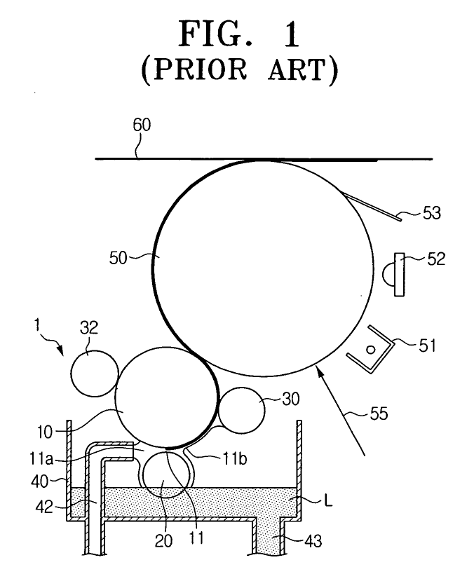

FIG. 2 illustrates a developing unit of a wet image forming apparatus according to an exemplary embodiment of the present invention,

FIG. 3 is a illustrates a liquid developer level in a developer receptacle of the developing unit shown in FIG. 2,

FIG. 4 is a view illustrating variations of an electric field acting on a developing roller, and

FIG. 5 illustrates a wet image forming apparatus having a developing unit in accordance with an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

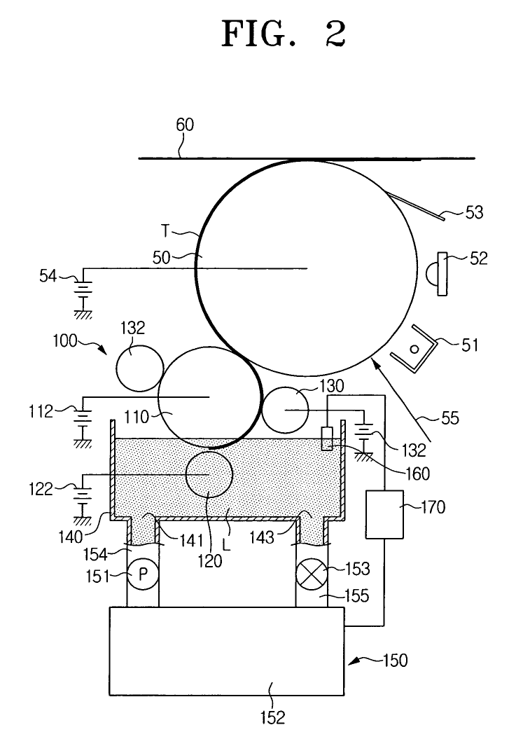

Referring to FIG. 2, a developing unit 100 of a wet image forming apparatus in accordance with an exemplary embodiment of the present invention comprises a developer receptacle 140, a deposit roller 120, a developing roller 110, a metering roller 130, and a developer-supplying unit 150.

The developer receptacle 140 contains a predetermined quantity of liquid developer L and fluidly communicates with the developer-supplying unit 150 through a developer inlet 141 and a developer outlet 143. Therefore, uniform concentrations and levels of the liquid developer L contained in the developer receptacle 140 are maintained. The liquid developer L is composed of solid toner particles and liquid developing carrier that dissolves the toner particles.

The deposit roller 120 is substantially disposed inside the developer receptacle 140 to submergingly rotate, preferably completely below a liquid developer surface L1. The deposit roller 120 attaches toner particles of the liquid developer L contained in the developer receptacle 140 to the surface of the developing roller 110, thereby forming a toner layer T thereon. A predetermined voltage is applied to the deposit roller 120 in order to generate an electrical force that carries the toner particles to the developing roller 110. The voltage applied to the deposit roller 120 is about 200˜500V higher than the voltage applied to the developing roller 110. Thus, the deposit roller 120 is electrically connected to a deposit power supply 122 which applies a predetermined voltage thereto.

The metering roller 130 removes excess liquid developing carrier attached to the developing roller 110, thereby keeping the toner layer T within a predetermined range of concentration. The metering roller 130 is disposed on a side of the developing roller 110 and rotates in contact with the developing roller 110. At this time, the metering roller 130 is disposed above the liquid developer surface L1 and is not in contact with the liquid developer L. Also, the voltage applied to the metering roller 130 is about 20˜400V higher than the voltage applied to the developing roller 110. So, the metering roller 130 is electrically connected to a metering power supply 132. The voltage is preferably determined by factoring in a concentration of the toner layer T is preferably about 20˜30% and a mass per unit area of the toner particles contained in the toner layer T is approximately about 1 80˜220 μg/cm².

The developing roller 110 carries the toner particles attached to the surface thereof by the deposit roller 120 and develops the electrostatic latent image formed on the photosensitive drum 50. The developing roller 110 is disposed above the deposit roller 120 to rotate apart from the deposit roller 120. At this time, some part of the developing roller 110 facing the deposit roller 120 submerges in the liquid developer L. In other words, the developing roller 110 is disposed to allow a gap between the developing roller 110 and the deposit roller 120 to completely submerge in the liquid developer L.

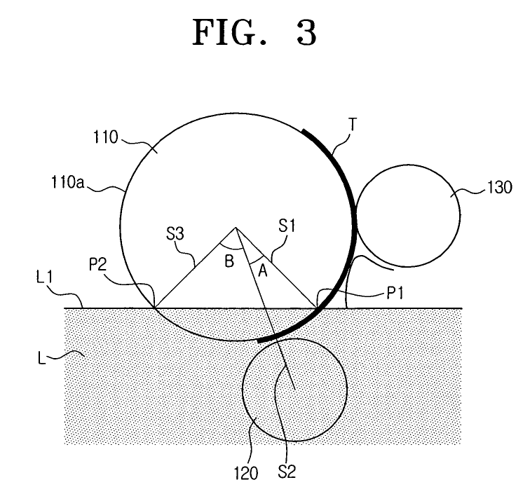

At this time, to uniformly maintain the quantity of the toner particles attached to the developing roller 110, the developing roller 110 is disposed to submerge in the liquid developer L by a predetermined depth. Then the level of the liquid developer L is preferably uniformly maintained during printing. The depth that the developing roller 110 is submerged in the liquid developer L, namely, the level of the liquid developer L contained in the developer receptacle 140 will be explained as an angle with respect to a rotational center of the developing roller 110 hereinafter. When the developing roller 110 is submerged in the liquid developer L, a circumferential surface of the developing roller 110 intersects with the surface L1 of the liquid developer L at 2 points P1, P2. A point that the circumferential surface of the developing roller 110 meets the surface L1 of the liquid developer L below the metering roller 130, namely, an intersection point to the right of the developing roller 110 in FIG. 3, refers to a first intersection point P1. Another point that the circumferential surface of the developing roller 110 meets the surface L1 of the liquid developer L on the opposite side of the developing roller from the metering roller 130, namely, an intersection point in the left of the developing roller 110 in FIG. 3, refers to a second intersection point P2. At this time, the developing roller 110 is disposed so that an angle A between a first straight line S1 and a second straight line S2 is over approximately 20°. When the liquid developer L level of the developer receptacle 140 cannot be varied, the developing roller 110 is moved and fixed so that it submerges to a predetermined depth so that the angle A between the first and second straight line S1 and S2 is over approximately 20°. Also, when the developing roller 110 cannot be moved, the level of the liquid developer L contained in the developer receptacle 140 varies so that the developing roller 110 submerges to a predetermined depth. Thus, the angle A between the first and second straight line S1 and S2 is over approximately 20°. Here, the first straight line S1 is a straight line that joins the first intersection point P1 and the rotational center of the developing roller 110. The second straight line S2 is a straight line that joins the rotational center of the developing roller 110 and a rotational center of the deposit roller 120. Also, the liquid developer L level is preferably controlled so that the angle A between the first and second straight line S1 and S2 is under approximately 40°. The developing roller 110 submerges enough in the liquid developer L so that the toner layer T on the developing roller 110 may wash away and the liquid developing carrier entering the metering roller 130 increases. The increase of the liquid developing carrier allows the concentration of the toner layer T on the developing roller 110 to decrease.

Also, the developing roller 110 is disposed so that an angle B, between the second straight line S2 and a third straight line S3, which joins the second intersection point P2 and the rotational center of the developing roller 110, is over approximately 20°. At this point, in case that there is the deposit roller 120 directly under the developing roller 110 or to the right under the developing roller 110, as shown in FIG. 3, when the angle A between the first and second straight lines S1 and S2 is approximately 20˜40°, the angle B between the second and third straight line S2 and S3 is preferably over approximately 20°.

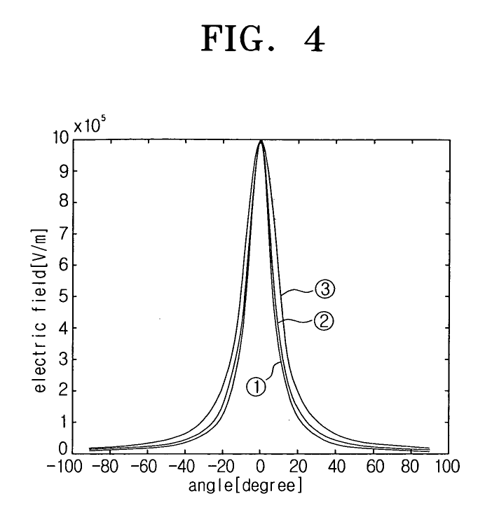

FIG. 4 shows a distribution of the electric field which is applied to the developing roller 110. The difference between the voltages applied to the developing roller 110 and the deposit roller 120 is about 250V. Also, FIG. 4 shows a distribution curve 1 of an electric field being applied to the developing roller 110 when a diameter of the developing roller 110 is about 16 mm and a diameter of the deposit roller 120 is about 8 mm. Curve 2 indicates a distribution of an electric field being applied to the developing roller 110 when diameters of the developing roller 110 and the deposit roller 120 are 16 mm, respectively. Curve 3 indicates a distribution of an electric field being applied to the developing roller 110 when diameters of the developing roller 110 and the deposit roller 120 are about 30 mm, respectively.

As shown in FIG. 4, the electric field strength being applied to an area of the developing roller 110 which has an angle from the second straight line S2 at over approximately 40° is very low. The electric field strength being applied to an area of the developing roller 110 which has an angle from the second straight line S2 below approximately 20°, is high, but varies greatly according to diameters of the developing roller 110 and the deposit roller 120. However, when an angle from the second straight line S2 is about 20˜40°, the electric field strength is appropriate and does not vary greatly according to diameters of the developing roller 110 and the deposit roller 120. In other words, when the liquid developer L level varies in this range, the amount of toner particles attached on the developing roller 110 varies within a small range. Therefore, it is preferable that the angle A between the first and the second straight line S1 and S2 is about 20˜40°.

Also, a voltage of about 500˜600V is applied to the developing roller 110. The toner that is attached to the developing roller 110 by the voltage and the deposit roller 120 is conveyed toward the photosensitive drum 50 which rotates in contact with the developing roller 110. Therefore, the developing roller 110 is electrically connected with a developing power supply 112 applying a predetermined voltage thereto. Also, a cleaning roller 132, which removes the toner remaining on the developing roller 110 after transfer to the photosensitive drum 50, is disposed on a side of the developing roller 110.

The developer-supplying unit 150 fluidly communicates with the developer receptacle 140. It supplies and withdraws the liquid developer L for the developer receptacle 140 so that the level of the liquid developer L is maintained constant. The developer-supplying unit 150 comprises a developer cartridge 152 containing the liquid developer L, a pump 151 supplying the liquid developer L from the developer cartridge 152 to the developer receptacle 140, and a developer supplying pipe 154 and a developer withdrawing pipe 155 that allows the developer receptacle 140 to fluidly communicate with the developer cartridge 152. To selectively withdraw the liquid developer L from the developer receptacle 140 to the developer cartridge 152, a pipe-blocling member 153, such as a valve or a pump, is disposed in the developer-withdrawing pipe 155.

Also, the developing unit 100 comprises a level sensor 160 sensing the liquid developer level of the developer receptacle 140 and a level controller 170 controlling the developer-supplying unit 150 according to a signal from the level sensor 160 to maintain the liquid developer level of the developer receptacle 140 constant. Any sensor capable of sensing the liquid developer level can be applied for the level sensor 160. When the level controller 170 senses the liquid developer level of the developer receptacle 140 to be under a predetermined level by the signal of the level sensor 160, it operates the pump 151 of the developer-supplying unit 150 to supply the liquid developer L in the developer cartridge 152 to the developer receptacle 140 until the liquid developer level reaches the predetermined level. When the level controller 170 senses the liquid developer level of the developer receptacle 140 is over the predetermined level, it operates the pipe-blocking member 153 to withdraw the liquid developer L from the developer receptacle 140 to the developer cartridge 152.

Hereinafter, an operation of the developing unit 100 comprising the same structure as described above will be explained referring to FIGS. 2 and 3.

The developer receptacle 140 contains a predetermined amount of the liquid developer L. The level sensor 160 senses the liquid developer level and transmits a level signal to the level controller 170. At this time, the liquid developer level of the developer receptacle 140 is determined by the angle A between the first straight line S1 and the second straight line S2 is 20˜40°. Here, the first straight line S1 joins the rotational center of the developing roller 110 and a point along the circumferential surface 110a of the developing roller 110 which intersects the surface L1 of the liquid developer L under the metering roller 130, namely, the first intersection point P1. The second straight line S2 joins the rotational center of the developing roller 110 and the rotational center of the deposit roller 120. Therefore, the gap between the deposit roller 120 and the developing roller 110 is completely submerged in the liquid developer L. At this time, the predetermined voltages are applied to the developing roller 110 and the deposit roller 120 by the developing power supply 112 and the deposit power supply 122, respectively. In the exemplary embodiment, a voltage of about 500˜600V is applied to the developing roller 110. A voltage applied to the deposit roller 120 is about 250V higher than that applied to the developing roller 110. Also, toner particles of the liquid developer L are positively charged. The toner particles of the liquid developer L in the gap between the developing roller 110 and the deposit roller 120 are attached to the surface 110a of the developing roller 110 by the electric force to form the toner layer T. At this time, some liquid developing carrier that dissolves the toner particles also moves to the developing roller 110. By rotation of the developing roller 110 and the deposit roller 120, the toner layer T is continuously formed on the developing roller 110. At this time, since the gap between the developing roller 110 and the deposit roller 120 is submerged in the liquid developer L and the electric force of the same strength operates at the entrance and the exit of the gap. Therefore, a thickness of the toner layer T formed on the surface 110a of the developing roller 110 is uniform. When the developing roller 110 rotates, the toner particles and developing carrier comprising the toner layer T on the developing roller 110 enter the metering roller 130. Then the metering roller 130 removes the excessive developing carrier attached to the developing roller 110. After the toner layer T passes through the metering roller 130, the toner layer T concentration is approximately 20˜30% and a mass per unit area of the toner particles contained in the toner layer T is approximately 1 80˜220 μg/cm².

The electrostatic latent image is formed on the photosensitive drum 50 rotating in contact with the developing roller 110 by the laser beam 55 emitted by the laser-scanning unit (not shown). Therefore, when the toner layer T formed on the developing roller 110 comes to face the electrostatic latent image via rotation of the developing roller 110, the electric field, which operates between the developing roller 110 and the photosensitive drum 50, allows the toner particles formed the toner layer T to move to the electrostatic latent image. Thus, the electrostatic latent image is developed into a visible image. The visible image developed by the toner particles supplied by the developing roller 110 is transferred to the printing paper (not shown) by the transferring unit 60 such as an intermediate transfer belt. The image transferred to the printing paper is fused thereon when passing through the fusing unit (not shown), thereby completing printing.

When the level of the liquid developer L of the developer receptacle 140 decreases below the predetermined level, after extensive printing operations, the level sensor 160 senses this condition and transmits a signal to the level controller 170. Then, the level controller 170 operates the developer-supplying unit 150 to supply the liquid developer L to the developer receptacle 140 until the liquid developer level of the developer receptacle 140 increases in the range described above.

Hereinafter, a wet image forming apparatus having the developing unit according to an embodiment of the present invention will be explained.

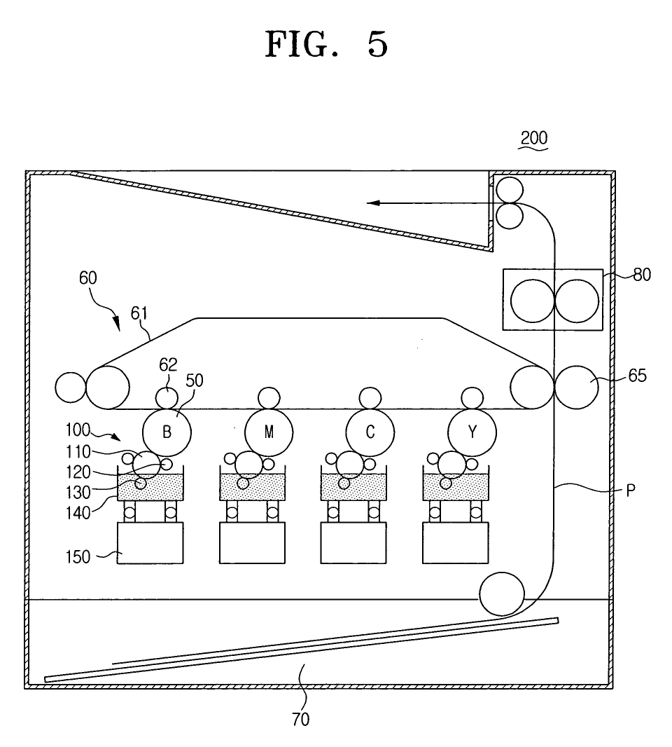

Referring to FIG. 5, the wet image forming apparatus 200 comprises a photosensitive drum 50 on which an electrostatic latent image is formed. A developing unit 100 develops the electrostatic latent image into a visible image, and a transferring unit 60 transfers the visible image formed on the photosensitive drum 50 to sheets of printing paper P. It further comprises a feeding unit 70 that loads a certain amount of the printing paper P and feeds the printing paper P one by one, and a fusing unit 80 which fuses the transferred image onto the printing paper P. For full color printing, the wet image forming apparatus 200 has four photosensitive drums 50 and four developing units 100 that form a black color image, a magenta color image, a cyan color image, and a yellow color image, respectively.

Besides the developing unit 100 and the transferring unit 60, a charging unit 51 for charging the surface of the photosensitive drum 50 by a predetermined voltage, a laser scanning unit (not shown) scanning a laser beam 55 for forming an electrostatic latent image on the photosensitive drum 50, a cleaning blade 53 for removing the toner remaining on the photosensitive drum 50 after being transferred to the printing paper P, and a charge eliminating unit 52 for eliminating a residual voltage on the photosensitive drum 50 are disposed around the photosensitive drum 50.

The developing unit 100 comprises a developer receptacle 140 for containing a predetermined volume of the liquid developer L, a developing roller 110 for conveying toner particles to the photosensitive drum 50, a metering roller 130 for regulating the toner particles and developing carrier attached on a surface of the developing roller 110, a developer-supplying unit 150 for supplying the liquid developer L to the developer receptacle 140, and a level controller 170 for controlling the liquid developer level of the developer receptacle 140. These elements are the same as aforementioned explanation, and therefore, a detailed explanation thereof will be omitted for clarity and conciseness. At this time, the level controller 170 controls the level of the liquid developer L contained in the developer receptacle 140 so that an angle between a first straight line S1, which joins a intersection point P1 where a circumference surface 110a of the developing roller 110 crosses the liquid developer surface L1 and a rotational center of the developing roller 110, and a second straight line S2, which joins the rotational center of the developing roller 110 and the rotational center of the deposit roller 120, is maintained in a range of about 20° to 40°.

The transferring unit 60 transfers the visible image formed on the photosensitive drum 50 to the printing paper P. Various types of transferring units 60 can be used. For example, one type of transferring unit 60 uses a transfer roller for directly transferring the image from the photosensitive drum 50 to the printing paper P. Another type of transferring unit 60 uses an intermediate transfer belt so that the image on the photosensitive drum 50 is transferred to the intermediate transfer belt and then the image transferred to the intermediate transfer belt is transferred to the printing paper P. The wet image forming apparatus 200 according to the exemplary embodiment uses the intermediate transfer belt 61. The transferring unit 60 comprises an intermediate transfer belt 61 which moves endlessly in a closed loop and images of four photosensitive drums 50 are, in serial order, transferred to and superposed on, four transfer backup rollers 62 for facilitating transfer of the image on the photosensitive drum 50 to transfer to the intermediate transfer belt 61, and a transfer roller 65 for transferring a full color image formed on the intermediate transfer belt 61 to the printing paper P. The voltage of about 700˜1000V is applied to the four transfer backup rollers 62. The printing paper P fed from the feeding unit 70 enters between the intermediate transfer belt 61 and the transfer roller 65.

Referring to FIG. 5, the operation of the wet image forming apparatus 200 as described above will be explained hereinafter.

When the controller (not shown) of the wet image forming apparatus 200 receives a printing order, it operates the charging unit 51 to charge the surface of the photosensitive drum 50 to approximately 900˜1000V. It controls the laser-scanning unit (not shown) to scan a laser beam corresponding to printing data. Then, an electrostatic latent image, having an electric potential of approximately 100V, is formed on the surface of the photosensitive drum 50. While the electrostatic latent image is being formed on the surface of the photosensitive drum 50, a toner layer is formed on the surface of the developing roller 110 by the deposit roller 120 and metering roller 130 and is conveyed to face the photosensitive drum 50. Here, since a process of forming the toner layer on the developing roller 110 is the same as described above, a detailed explanation thereof will be omitted for clarity and conciseness. When the photosensitive drum 50 rotates and the electrostatic latent image comes to face the developing roller 110, the toner particles attached on the developing roller 110 move to the photosensitive drum 50 by the electric force operating between the developing roller 110 and the photosensitive drum 50. Thus, the electrostatic latent image is developed. At this time, since the electrical potential of the electrostatic latent image is lower than the other area of the photosensitive drum 50, the toner particles moved from the developing roller 110 only attach on the electrostatic latent image. The toner particles developing the electrostatic latent image on the photosensitive drum 50 are transferred to the intermediate transfer belt 61 by the transfer backup roller 62 being applied the voltage of about 700˜1000 V. While the intermediate transfer belt 61 moves endlessly in a closed loop, four predetermined color toner images formed on the four photosensitive drums 50 are transferred to and superimposed on the intermediate transfer belt 61, thereby forming a full color image. The full color image formed on the intermediate transfer belt 61 is transferred to the printing paper P being fed from the feeding unit 70 by the transfer roller 65. The full color image, transferred to the printing paper P, is fused thereon P when passing through the fusing unit 80. Then the printing paper P is discharged to the outside of the wet image forming apparatus 200.

When the level of the liquid developer L contained in the developer receptacle 140 of the developing unit 100 decreases so that the angle between the first straight line S1 and the second straight line S2 is below a predetermined angle, the wet image forming apparatus 200 allows the developer-supplying unit 150 to supply the liquid developer L, thereby maintaining the liquid developer level at the predetermined level.

While the invention has been shown and described with reference to certain embodiments thereof, it will be understood by those skilled in the art that various changes in form and details may be made therein without departing from the spirit and scope of the exemplary embodiments of the invention as defined by the appended claims.

What is claimed is:

1. A developing unit comprising:
a developer receptacle containing liquid developer,
a deposit roller rotatively disposed substantially below a surface of the liquid developer in the developer receptacle;
a developing roller rotatively disposed over the deposit roller so that a part thereof submerges in the liquid developer, and
a metering roller rotatively disposed on a side of the developing roller over the surface of the liquid developer;
wherein the level of the liquid developer is maintained so that an angle A between a first straight line joining a rotational center of the developing roller and a first intersection point where a circumferential surface of the developing roller intersects with the surface of the liquid developer below the metering roller, and a second straight line joining the rotational center of the developing roller and a rotational center of the deposit roller is over about 20°.

2. The developing unit of claim 1, wherein the level of the liquid developer is maintained so that the angle A between the first straight line and the second straight line is below about 40°.

3. The developing unit of claim 1, wherein the developing roller is disposed so that an angle B between the second straight line and a third straight line joining the rotational center of the developing roller and a second intersection point where the circumferential surface thereof intersects with the surface of the liquid developer on the opposite side of the developing roller from the metering roller is over about 20°.

4. The developing unit of claim 1, further comprising:
a level sensor sensing the level of the liquid developer,
a developer-supplying unit which fluidly communicates with the developer receptacle and the developer-supplying unit supplying and withdrawing the liquid developer;
a level controller controlling the developer-supplying unit according to a signal of the level sensor so as to uniformly maintain the liquid developer level.

5. The developing unit of claim 1, further comprising:
a deposit power supply applying a voltage to the deposit roller,
a developing power supply applying a voltage to the developing roller;
wherein the voltage applied to the deposit roller is about 200˜500V higher than the voltage applied to the developing roller.

6. The developing unit of claim 5, wherein the developing power supply applies a voltage of about 500˜600V to the developing roller.

7. A wet image forming apparatus comprising:
a photosensitive medium on which an electrostatic latent image is formed;
a developing unit developing the electrostatic latent image into a visible image; and
a transferring unit transferring the visible image formed on the photosensitive medium to printing paper,
wherein the developing unit comprises a developer receptacle containing liquid developer, a deposit roller rotatively disposed substantially below a surface of the liquid developer of the developer receptacle, a developing roller rotatively disposed in contact with the photosensitive medium over the deposit roller so that a portion thereof submerges in the liquid developer, a metering roller rotatively disposed on a side of the developing roller over the surface of the liquid developer, a level sensor disposed in the developer receptacle which senses the level of the liquid developer, a developer-supplying unit supplying and withdrawing the liquid developer from the developer receptacle, and a level controller controlling the developer-supplying unit according to a signal of the level sensor so that the level of the liquid developer is maintained to allow an angle A between a first straight line joining a rotational center of the developing roller and a first intersection point where a circumferential surface of the developing roller intersects with the surface of the liquid developer below the metering roller and a second straight line joining the rotational center of the developing roller and a rotational center of the deposit roller to be over about 20°.

8. The wet image forming apparatus of claim 7, wherein the level of the liquid developer is maintained so that the angle A between the first straight line and the second straight line is below about 40°.

9. The wet image forming apparatus of claim 7, wherein the developing roller is disposed so that an angle B between the second straight line and a third straight line joining the rotational center of the developing roller and a second intersection point where the circumferential surface thereof intersects with the surface of the liquid developer on the opposite side of developing roller from the metering roller is over about 20°.

10. The wet image forming apparatus of claim 7, further comprising:
a deposit power supply applying a voltage to the deposit roller,
a developing power supply applying a voltage to the developing roller,
wherein the voltage applied to the deposit roller is about 200˜500V higher than the developing roller.

11. The wet image forming apparatus of claim 10, wherein the developing power supply applies a voltage of about 500˜600V to the developing roller.
